(19) United States
(12) Patent Application Publication
(10) Pub. No.: US 2009/0231829 A1
(43) Pub. Date: Sep. 17, 2009

(54) Lightwall instrument

(76) Inventor: Eugene Wang, Temple City, CA (US)

Correspondence Address: DAVID AND RAYMOND PATENT FIRM, 108 N. YNEZ AVE., SUITE 128, MONTEREY PARK, CA, 91754, US

(21) Appl. No.: 12/319,449

(22) Filed: Jan. 7, 2009

Related U.S. Application Data
(60) Provisional application No. 61/069,788, filed on Mar. 17, 2008.

(51) Int. Cl. G03B 15/02; F21V 1/08

(52) U.S. Cl. 362/18; 362/311.01

(57) ABSTRACT

A lightwall instrument for photographic purposes includes a supporting frame, a light source, a diffuser wall, and one or more shading walls. The position of the light source is adjustable. The shape of the diffuser wall is selectively changed for different effects. The present invention provides a convenient and flexible lightwall instrument for better effect of photographs or films. The light generated by the lightwall instrument is soft, even, and saturated. The effects are highly adjustable. The operation is easy.

### CROSS REFERENCE TO RELATED APPLICATION

This is a non-provisional application of a provisional application having an application No. 61/069,788 and a filing date of Mar. 17, 2008.

### BACKGROUND OF THE PRESENT INVENTION

1. Field of Invention

The present invention relates to a lightwall instrument, and particularly to a lightwall instrument for improving the effect of photographs and film.

2. Description of Related Arts

Photography is the art of lights and shadows. When a light shines on an object which doesn't generate light, the surface of the object will reflect some ways of the light, presenting as particular colors; and absorb the other ways of the light. Where there is no light reflect, it is shadow. How to manage the light, how to arrange the lights and shadows critically dominates the effect of a photograph. A successful photographer needs to have the unique sense to catch the fleeting moment and position in a real environment. While, in a studio, suitable instruments and proficient skills are more important.

Generally, a lightwall instrument is used as a light source simulating the nature light such as sun light. Currently, light bulb is still the only controllable light source used in studio. Using flash light, enough brightness can be provided. But for acceptable effect, good performance, there are many other requirements. Particularly for digital technique which is overwhelming in this industry, a lot of special and new aspects should be taken care.

First, the coverage of the light source needs to be large. If the light source is only a point, such as a regular light bulb, only a small part of the surface of the object of the photograph, which is directly facing this point, can be lighted directly. Other part of the surface of the object, such as the sides and the back of the object, will stay in the shadow. In this manner, many details of the object can not be recorded. Also, because most objects have irregular surface, the extruded parts will leave a shadow behind. For example, people's faces are quite easy to have shadows and destroy the effect. The distance between the object and the light source also affect the coverage. The longer the distance is, the smaller the coverage is. Besides the area of the light source, the direction also affects the coverage. A curved light source will provide light from different directions than a flat surface. In such a manner, a 3D object can be exposed more sufficiently to the camera.

Second, the quality of the light is required. It includes softness, saturation, smoothness, uniformity, etc. The quality of the light is more important for digital photography than for the traditional film photography. The tolerance of the film is 16:1, while the tolerance of the digital camera is only 5:1. The light level of a digital camera is from 0 to 255, but only level 10 to 245 can be sensed by human eyes during to the displaying instruments and printing technique. This requests the light should be distributed from level 10 to level 245 to provide high saturation. Softness is another fact. Only reflected light can be recorded by camera, but smooth surfaces of many objects, such as glasses, human face with oil, will reflect the image of the light source. That's the reason many pictures have hot spot (white spot) which is the reflection of the light bulb. The hot spot is called noise and should be eliminated. To control the color temperature (Kevin temperature) is also important using artificial light source. Color temperature is related to the distance the light travels from the source to the object. If the light has different paths to reach the object, the color temperature will be different. As a result, the color of the object will shift. The color will shift to blue with higher color temperature, and shift to red with lower temperature. Reflect on picture, the object will have fault colors.

Third, the operation of the light instruments should be convenient and flexible. The instruments should provide multiple functions for some special effects.

Currently, the most popular photographic lighting device is soft box. A soft box is an enclosure around a bulb. The bulb locates at the bottom of the box. The back and side walls of the box are lined with a bright surface which is aluminized fabric surface or aluminum foil to as a reflector. There is also a transparent screen made of a layer of thin cloth of fabric mounted in the front wall of the box as a diffuser, as shown in reference number 14 of U.S. Pat. No. 6,733,145. The purpose of a soft box is to create soft diffused light by diffusing the directing light from the bulb, and the reflecting light from the bright surface through the diffuser. Soft box light are soft and even. The diffuser increases the coverage of the lighting, and de-emphasizes lines and blemishes on the face of a human subject.

There are several disadvantages limiting the usage of soft box.

First, the color temperature of soft box light is not even. The light generated by soft box includes directing light and reflecting light. They have different path to reach the object. This means the distance is different. As mentioned before, the color temperature will be different consequently.

Second, the depth of the light bulb can't be adjusted. The depth means the distance between the bulb and the disputer. The depth will largely affect the softness of the light, but the disputer is fixed on the soft box as well as the bulb. The distance between the disputer and the bulb can not be adjusted according to different photographic objects.

Third, the dimension of the soft box is generally limited. Most of currently using soft box is only in foot square, it is difficult to cover object like an adult human. For other objects such as automobile, special made soft boxes are needed but are very expensive. Generally the disputer has only a flat surface, and can not provide curved surface. This will enlarge the reflection image of the light source (hot spot) and damage the effect of the photograph.

Also, it is not convenient to use the soft box in studio. If more layers of disputer are need, people have to use separate stand. If narrow light is requested, a special cover has to be mounted over the soft box. The subject of photograph can not have a right front light because camera can not be places in front of the soft box or behind it. In this way, the camera and the soft box will block each other. Generally the soft box is supported by a tripod. But the soft box is heavy, and the dimension is relatively larger than the base of the tripod, therefore it is not easy to move the soft box, and make it stand stably.

Besides the limitation of the equipment, there is also some misunderstanding of using the light source. For example, in order to eliminate shadows, one of the methods used by many photographers is adding another assistant light source opposing the main light source over the shadow. This may diminish some shadows, but it doesn't help the image of the front face, and causes more hot spots.

### SUMMARY OF THE PRESENT INVENTION

An object of the present invention is to provide a method and instrument to provide a lightwall in order to improve photograph effect.

Another object of the present invention is to provide a lightwall instrument which can produce a virtually single wall of light source having a relatively large coverage to reduce hot spots from multiple soft boxes to be used for such large coverage conventionally.

Another object of the present invention is to provide a lightwall instrument having an adjustable depth of the light source.

Another object of the present invention is to provide a lightwall instrument having an adjustable depth of diffuser.

Another object of the present invention is to provide a lightwall instrument to provide light with even color temperature.

Another object of the present invention is to provide a lightwall instrument to provide saturate light.

Another object of the present invention is to provide a lightwall instrument to reduce lighting reflection.

Another object of the present invention is to provide a lightwall instrument to reduce noise (hot spots).

Another object of the present invention is to provide a lightwall instrument with curved surface.

Another object of the present invention is to provide a lightwall instrument which is flexible to provide various functions.

Another object of the present invention is to provide an innovative diffuser layer which can evenly diffuse light and provide softness light source.

Accordingly, in order to accomplish the above objects, the present invention provides a lightwall instrument, comprising:

a supporting frame;

a light source which is adjustably supported by the supporting frame and providing light; and

a diffuser wall which is adjustably supported by the supporting frame in front of the light source for diffusing the light provided by the light source so as to illuminate the photographic subject.

Moreover, the present invention provides a method of lighting photographic subject, comprising the step of:

(a) positioning the supporting frame with the diffuser wall facing the target object;

(b) positioning the light source to project light onto the diffuser wall;

(c) changing the shape of the diffuser wall for preferred illuminating effect;

(d) blocking undesired light from the lightwall instrument;

(e) illuminating the target object by diffusing the light from the light source through said diffuser wall.

These and other objectives, features, and advantages of the present invention will become apparent from the following detailed description, the accompanying drawings, and the appended claims.

### BRIEF DESCRIPTION OF THE DRAWINGS

FIG. 1 is the perspective view of the lightwall instrument according to a preferred embodiment of the present invention wherein the diffuser wall and the shading wall are detached from the supporting frame.

FIG. 2 is the top view of the lightwall instrument according to the above preferred embodiment of the present invention when it is demonstrated to be operated in a wider lighting mode.

FIG. 3A is the top view of the lightwall instrument according to the above preferred embodiment of the present invention when it is demonstrated to be operated a narrower lighting mode.

FIG. 3B is the top view of the lightwall instrument according to the above preferred embodiment of the present invention when it is demonstrated to be operated in a side lighting mode.

FIG. 3C is the top view of the lightwall instrument according to the above preferred embodiment of the present invention when it is demonstrated to be operated in a half-size lighting mode.

FIGS. 4A and 4B are the top views illustrating two lightwall instruments cooperated to form a wide lightwall arrangement according to the above preferred embodiment of the present invention.

FIG. 5 is a perspective view illustrating a plurality of lightwall instruments forming a continuous lightwall arrangement according to the above preferred embodiment of the present invention.

FIG. 6 is a perspective view illustrating an adjustable device of the lightwall instrument for the light source thereof according to the above preferred embodiment of the present invention.

FIG. 7 is a perspective view of the diffuser wall of the lightwall instrument according to the preferred embodiment of the present invention, showing a diffusing layer sandwiched between two holding layers.

### DETAILED DESCRIPTION OF THE PREFERRED EMBODIMENT

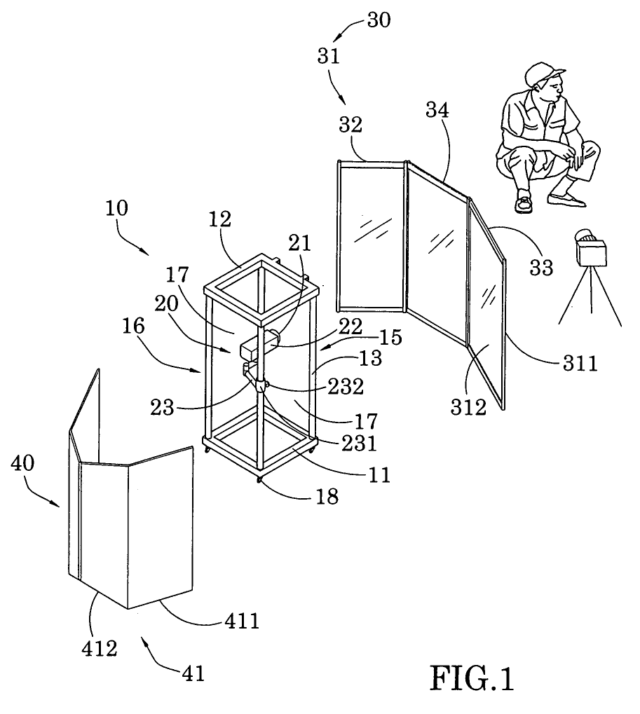

Referring to FIG. 1 of the drawings of the present invention, a lightwall instrument embodied as photographic light source for better effect of photographs and film is illustrated, in which the lightwall instrument comprises a supporting frame 10, a light source 20, a diffuser wall 30, and a shading arrangement 40. The supporting frame 10 comprises a square-shaped bottom frame 11, a square-shaped top frame 12, and four columns 13 extended between corners of the bottom frame 11 and corners of the top frame 12.

In a preferred embodiment of the present invention, the bottom frame 11 and the top frame 12 is embodied to have the same size of 600 mm×500 mm. The four columns 13 connect the four corners of the bottom frame 11 and the top frame 12 respectively to form a cubic frame. This cubic frame has a front face 15, a back face 16, and two side faces 17. The height of the cubic frame is preferred to be higher than 2000 mm. In an embodiment of the present invention, the height of the cubic frame is embodied as 2500 mm. The bottom frame 11 also has four floor wheels 18 so the lightwall instrument can be easy moved on wheel. When stopped, the lightwall instrument can stand stably. The front face 15 of the supporting frame 10 is supporting the diffuser wall 30, and the back face 16 of the supporting frame 10 is supporting the light source 20 and the shading wall.

The light source 20 comprises a bulb 21, a bulb seat 22, and a pivot connector 23. The bulb 21 is electrically connected with a power source, and provides constant light or flash light. The bulb 21 is installed in a bulb seat 22. The bulb seat 22 is adjustably mounted on one of the columns 13 of the back face 16 of the supporting frame 10 through a pivot connector 23. On one end of the pivot connector 23 is a slideable sleeve 231. The slideable sleeve 231 is clutching the column 13. Using the column 13 as a track, the pivot connector 23 can slide along the column 13 vertically. Using the column 13 as a shaft, the pivot connector 23 can move around the column 13 for 360° horizontally. The connector also has a fastener 232 to fix the position of the slideable sleeve 231 on the column 13. On the other end of the pivot connector 23 is a pivot junction which is mechanically connected with the bulb seat 22 and allows the bulb seat 22 turn the direction 360° horizontally. In this manner, the relative position of the light source 20 is able to be adjusted in 3 dimensions, and the direction of the light is also adjustable. This gives the capability of changing the depth of the light source 20. If necessary, more than one light source 20 can be mounted on one or two of the columns 13. For example, the lightwall instrument can use two light sources 20 for the effect of “moonlights”.

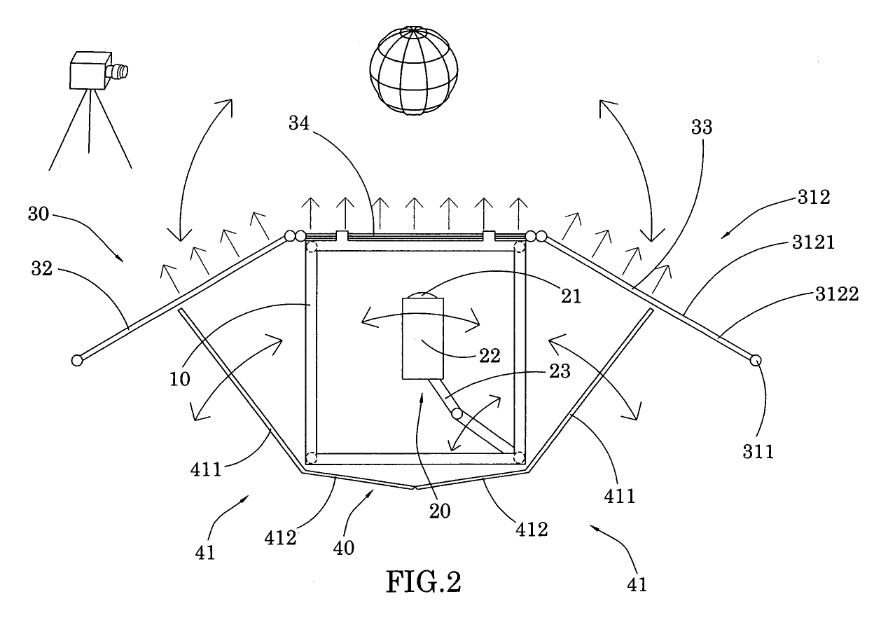

Referring to FIGS. 1 and 2 of the drawings, the diffuser wall 30 comprises three pieces of diffusing wall unit 31. Each diffusing wall unit 31 has a wall frame 311, and a diffusing wall screen 312. The wall frame 311 defines the contour of the frame as a rectangle. In a preferred embodiment of the present invention, the size of the rectangle is embodied as 2500 mm×600 mm.

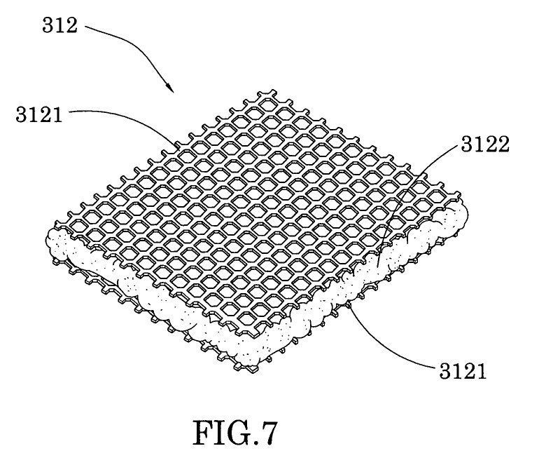

As shown in FIG. 7, the diffusing wall screen 312 is supported by the wall frame 311 to form a flat surface. The diffusing wall screen 312 has a sandwich structure which comprises two holding layers 3121 and one diffusing layer 3122. The diffusing layer 3122 is made of natural fiber or artificial fiber with a predetermined thickness. In a preferred embodiment, the material of the diffusing layer 3122 is polyester having a predetermined thickness. The two holding layers 3121 are web layers made of meshy cloth which are adhered and attached to two sides of the diffusing layer 3122 so as to hold the diffusing layer 3122 to form the diffusing wall screen 312. In addition, the diffusing layer 3122 and the two holding layers 3121 are sewn together for strengthening. It is appreciated to the diffusing layer 3122 that the light beams emitted from the light source 20 can be evenly diffused through the diffusing wall screen 312 to produce softness lighting.

The three diffusing wall units 31 are pivotally connected side by side to form the diffuser wall 30. The left and right diffusing wall unit 32, 33 can be pivoted along the middle diffusing wall unit 34 in 360°. This makes the diffuser wall 30 flexible to provide different forms for various lighting effects. The wall frame 311 of the middle diffusing wall unit 34 also has two connectors 313 at the two top corners. These two connectors 313 can detachably attach the diffuser wall 30 onto the front face 15 of the supporting frame 10. In this way, the middle diffusing wall unit 34 covers the front face 15 of the supporting frame 10. The left and right diffusing wall units 32, 33 are suspended by the middle diffusing wall unit 34 with the pivotal connection. The left and right diffusing wall units 32, 33 can be pivoted backward to cover the left and right side faces 17 of the supporting frame 10, or stay in any angle with the middle diffusing wall unit 34 for determined effects.

When the diffuser wall 30 is attached on the supporting frame 10, the light source 20 is positioned behind the diffuser wall 30 for illuminating towards the diffuser wall 30. When the light source 20 is on, the light will shine on the whole diffusing wall unit 31. The light will then transmit through the diffusing wall screen 312, and be diffused to all directions. In this way, the whole screen becomes a light source 20 to illuminate the object in front of the diffuser wall 30. In other words, the diffuser wall 30 diffuses the light for softening the light being projected at the target object so as to create a planar light source towards the target object.

Referring to FIGS. 1 and 2 of the drawings, the shading arrangement 40 comprises two shading walls 41. Each shading wall 41 has a side panel 411 and a back panel 412 which are pivotally connected together edge-to-edge. The side panel 411 is as large as the side face 17 of the supporting frame 10. The pivot of the connection of the two panels is detachably attached at one back corner of the supporting frame 10. In this manner, the side panel 411 of each shading wall 41 can be pivoted forward to cover the side face 17 of the supporting frame 10, or stay in any angle with the side face 17 of the supporting frame 10 for determined effects. The two back panels 412 of the two shading walls 41 can be pivoted towards each other for closing the back face 16 of the supporting frame 10. It is worth to mention that the width of each back panel 412 is larger than half of the width of the back face 16 of the supporting frame 10. In this manner, when the two back panels 412 are closed side by side, it makes an angle instead of a flat panel. This gives more space for the light source 20 to be positioned. So the light source 20 and the diffuser wall 30 can have longer distance if needed.

The panels are made of nontransparent and nonreflecting material. The purpose of the shading wall 41 is to prevent light leaking from the back of the lightwall instrument, because only light from the diffuser wall 30 is manageable and expected. The material of the shading wall 41 is not reflecting is also important. This will diminish the reflecting light which has different color temperature from the directing light and can produce fault color. Another purpose of the shading wall 41 is to control the amount of light reaching the subject of the photograph. The side panel 411 of the shading wall 41 can selectively block the light source 20. By adjusting the blocking angle of the side panel 411 of the shading wall 41, the amount of light can be controlled to reach the diffuser wall 30.

Using the lightwall instrument of the present invention is flexible and convenient. According to the requirement of making high quality of photograph, this invention can provide the photographer various capability.

The lightwall instrument of the present provides a very large coverage. The height of the diffuser wall 30 is larger than 2000 mm, which is higher than most human. This guarantees a sufficient coverage vertically. The width of the three diffusing wall units 31 is more than 1500 mm, which is enough to cover a small group of people. If the subject of the photograph is really large, such as an automobile, two or more such lightwall instruments of the present invention can be line up side by side to form one continuous large diffuser wall 30. In this manner, the width of the diffuser wall 30 can be unlimited theoretically. To line up several lightwall instrument of the present invention is very convenient. Just move the supporting frame 10 on floor wheel into the position, extend the three diffusing wall units 31 of each diffuser wall 30 into a flat panel, line up the diffuser walls 30 continuously, then a much larger diffuser wall is ready.

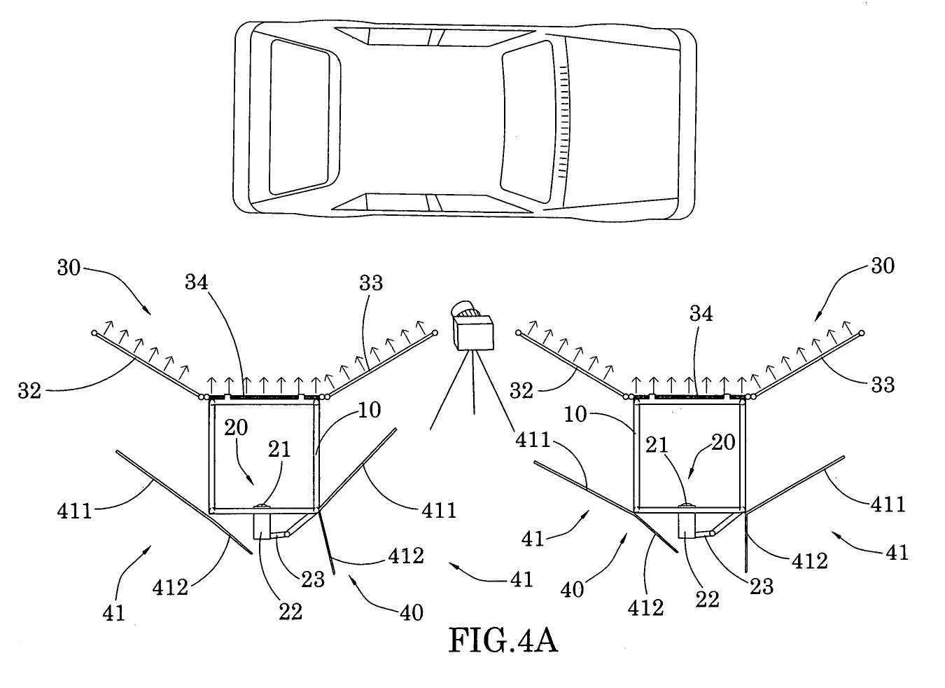

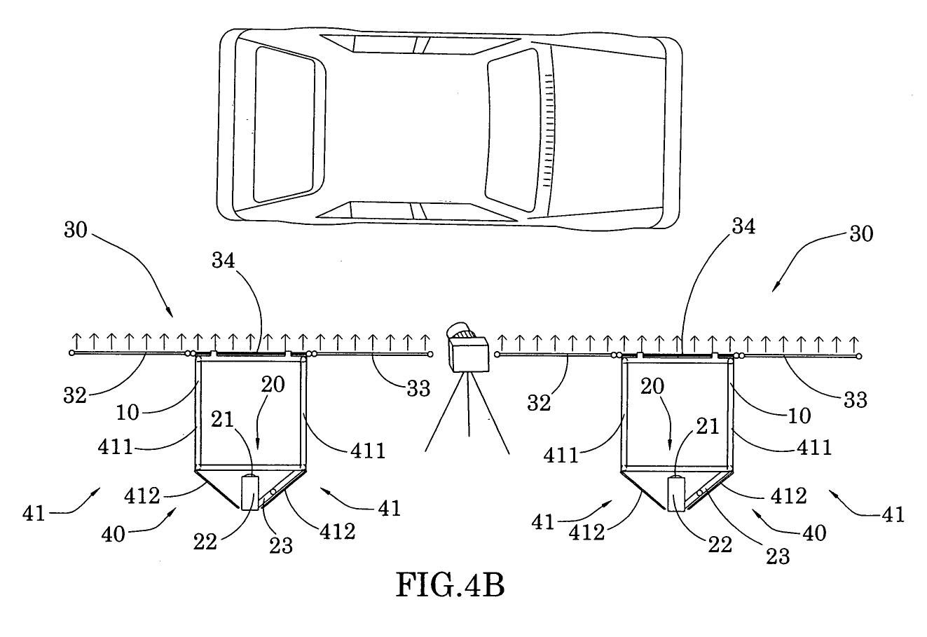

Since the diffuser wall 30 has a large area, the camera can be even placed in front of the lightwall instrument without blocking the light. So the subject of the photograph can have a right front light illumination. Referring to FIG. 4 of the drawings, if two lightwall instruments of the present invention are used, a small gap can be left between two diffuser walls 30 for the camera. The photographer can stay behind the diffuser walls 30 to operate the camera. In this way, the photographer will not block the light.

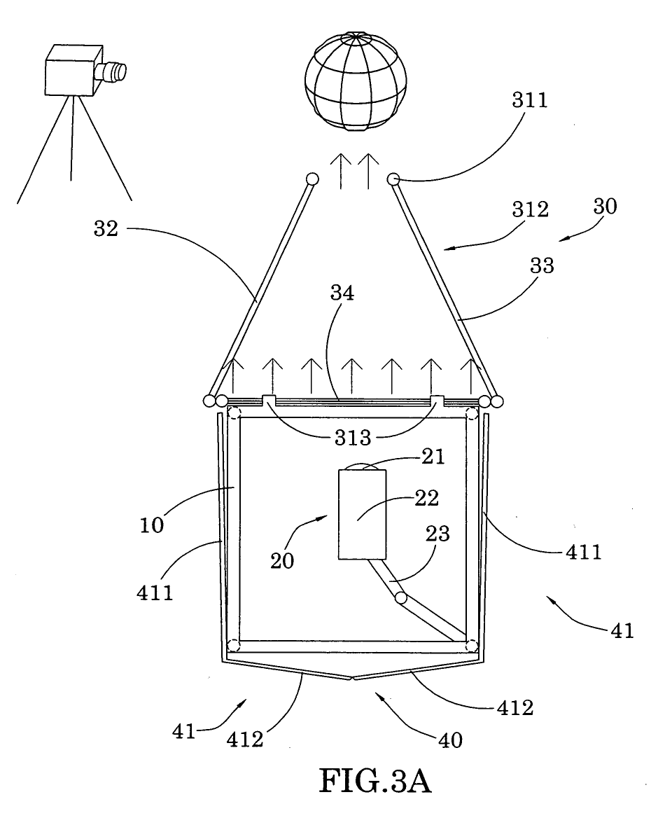

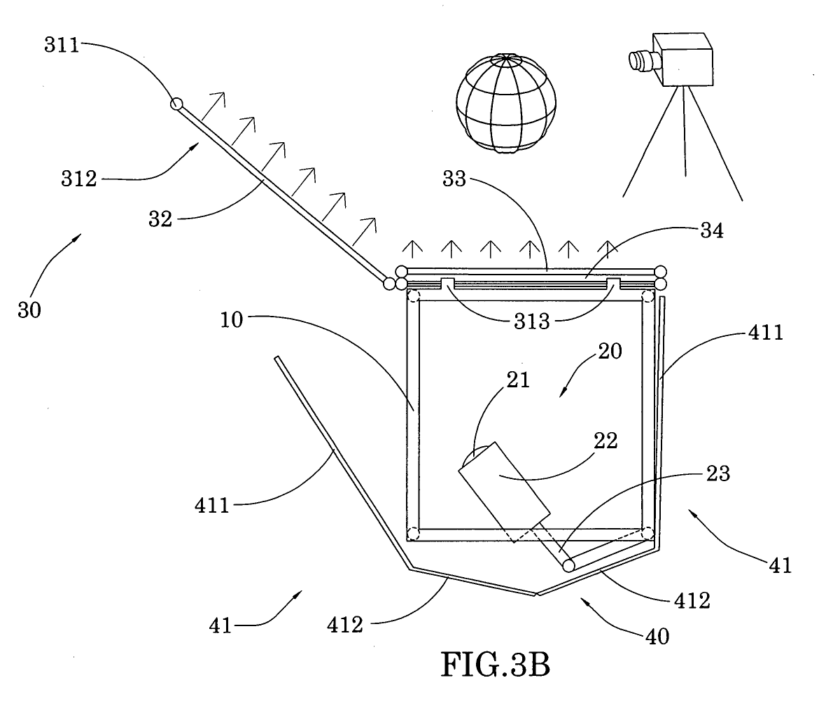

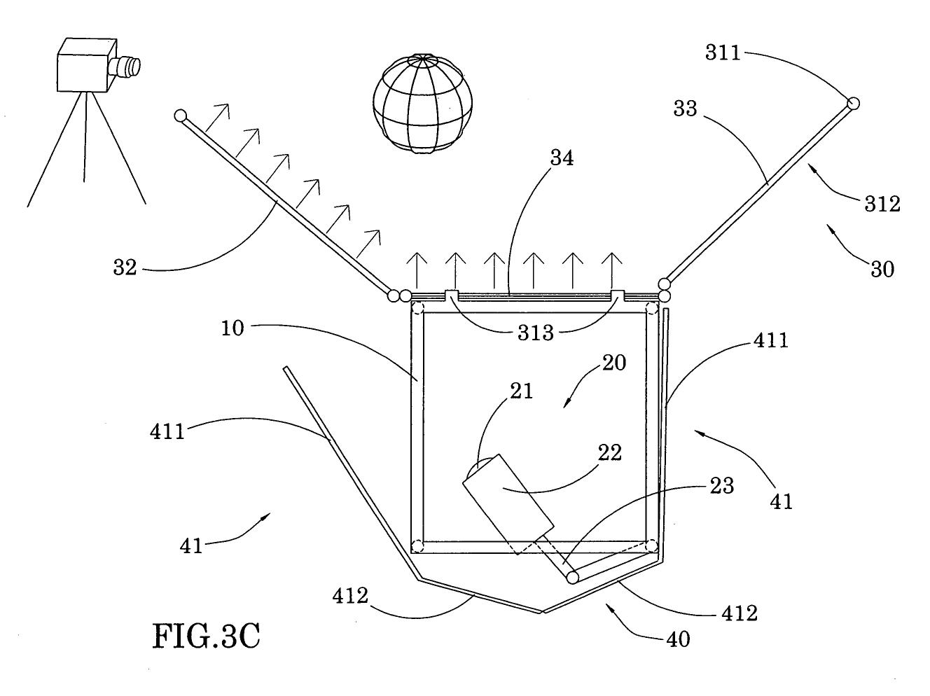

Referring to FIGS. 2 and 3, since the three diffusing wall units 31 are pivotally connected, the angle between each two diffusing wall units 31 can be changed. This can provide a curvature to the diffuser wall 30. Depending on the dimension of the subject of the photograph, the curvature can also be adjusted flexibly. Referring to FIG. 3C, if the subject is small, and lighting on the side of the subject is require, the left and right diffusing wall units 32, 33 can be pivoted forward to form a concave surface. The more the two diffusing wall units are pivoted forward, the larger the curvature of the concave is, so that the light can cover more area of the subject.

In another application, referring to FIG. 2, if the subject has a shiny polished surface, or transparent material such glass, the surface of the subject will reflect the image of the light source 20. This reflection is call hot spot or white spot which is considered as noise and is desired to be eliminated. In this situation, the left and right diffusing wall units 32, 33 can be pivoted backward to for a convex of the diffuser wall 30. Most subjects of photograph also have convex surfaces. It can be imagined, when a convex surface reflects a convex light source 20, there is only a narrow line can be seen from any direction. This design largely diminishes the area of the hot spot. Also, when the diffuser wall 30 is in a convex, the distance from the light source 20 to each diffusing wall unit 31 can be the same, so the color temperature is the same. The light illuminating on the subject of the photograph will be even, and the transmission from the illuminated area to the area of shadow will be gentle.

Referring to FIG. 3B, the left or right diffusing wall unit 32, 33 can also be pivoted to overlap the middle diffusing wall unit 34. It means the lightwall instrument can be easily added one or two more layers of diffusing wall units to further reduce the light, and increase the softness. Referring to FIG. 3A, the three diffusing wall units 31 can also form a triangle when the left and right diffusing wall units 32, 33 are pivoted toward each other to give special light effect. If there is a gap left between the edges of the left and right diffusing wall units 32, 33, a narrow line light source is available. The width of the line light source can be controlled.

Cooperating with the shading wall 41 can provide more effects. Referring to FIGS. 2 and 3, the side panel 411 of the shading wall 41 can partially block the light shining on the diffusing wall unit 31. For example, when taking photo for two people, the one closer to the lightwall instrument will be brighter. To make the light even, the side panel 411 can block some light shining on this person. For anther example, by opening a narrow gap for illuminating some particular part of the subject, such as the shoulder of a people, will emphasis the contract of light and give some special effects.

The operation of the lightwall instrument of the present invention is very convenient. The first step is to position the supporting frame 10. The supporting frame 10 is firm and stable, with the floor wheels it is easy to be positioned. So the distance between the diffusing wall unit 31 and the subject of the photograph is easy to adjust. When the position of the supporting frame 10 is fixed, the position of the light source 20 can be adjusted. The height of the light source 20 can be easily changed from bottom to the top of the supporting frame 10 according to the height of the subject. The depth of the light source 20 is also ready to be changed by whirling the pivot connector 23. It is worth to mention, if the depth is not enough, the whole diffuser wall 30 can be detached from the supporting frame 10 and stand away from the light source 20 to give enough distance.

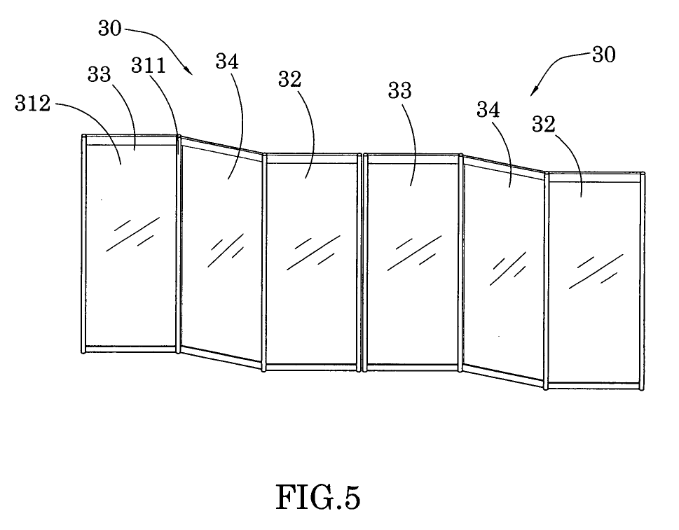

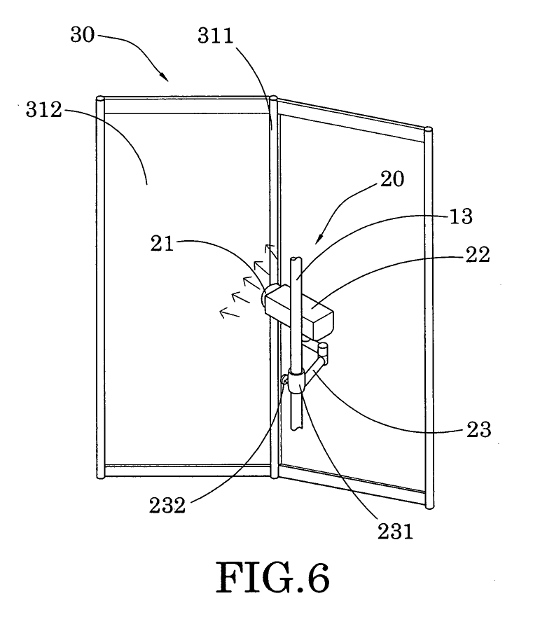

Next step is to adjusting the pivoting angle of the diffusing wall units 31. The diffusing wall units 31 are pivotally connected with each other, so changing the angle is just like opening and closing windows or doors. There are various possible arrangements for one or plural of diffuser wall 30s to fulfill the photographer's requests. Further more, using the shading wall 41 can provide even more possibilities for better effects. FIG. 5 is flow chart of the method of using the lightwall instrument.

In summary, the present invention provides a convenient and flexible lightwall instrument for better effect of photo or film. The light generated by the lightwall instrument is soft, even, and saturated. The effects are highly adjustable. The operation is easy.

It is worth to mention, the vertical edge of the wall frame 311 and the vertical edge of the shading wall 41 also have magnetic material embedded. So when two vertical edges are closed to each other, they will be magnetically attached together. This will make it easier to form a continuous panel, or form a closed contour.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A lightwall instrument, comprising:
a supporting frame having a front face, two side faces, and a back face;
a light source adjustably supported by said supporting frame; and
a diffuser wall, having a predetermined height to provide a relatively large diffusing area, detachably supported by said supporting frame at said front face thereof, such that when the light from said light source is projected towards said diffuser wall, said diffuser wall diffuses said light for softening said light being projected at a target object so as to create a planar light source towards said target object.

2. The lightwall instrument, as recited in claim 1, wherein said diffuser wall comprises a middle diffusing wall unit supported at said front face of said supporting frame, and left and right diffusing walls pivotally coupled with said middle diffusing wall, wherein each of said left and right diffusing walls is adjustably fold at one position to cover said corresponding side face and at another position to stay at a desired angle with respect to said middle diffusing wall unit, wherein said left and right diffusing walls are adapted to pivotally fold to overlap with said middle diffusing wall for enhancing light diffusion effect of said diffuser wall.

3. The lightwall instrument, as recited in claim 2, wherein each of said left, right, and middle diffusing wall units comprises a wall frame and a diffusing wall screen supported thereat to form a flat surface, wherein said diffusing wall screen comprises two holding layers and a diffusing layer sandwiched therebetween, such that when the light from said light source is projected towards said diffusing layer, said diffusing layer diffuses and softens said light before the light projects at the target object.

4. The lightwall instrument, as recited in claim 1, wherein said supporting frame comprises a square-shaped bottom frame, a square-shaped top frame, and four columns extended between corners of said bottom frame and corners of said top frame, wherein said light source is movably mounted at one of said columns at a position between said front and back faces for generating said light towards said diffuser wall.

5. The lightwall instrument, as recited in claim 3, wherein said supporting frame comprises a square-shaped bottom frame, a square-shaped top frame, and four columns extended between corners of said bottom frame and corners of said top frame, wherein said light source is movably mounted at one of said columns at a position between said front and back faces for generating said light towards said diffuser wall.

6. The lightwall instrument, as recited in claim 4, wherein said light source comprises a light bulb and a pivot connector which is extended from said light bulb and is movably mounted at one of said columns in such a manner that when said pivot connector is adjustably slid along said respective column, said light bulb is selectively adjusted its vertical orientation between said top and bottom frame and is pivotally adjusted its light projecting angle.

7. The lightwall instrument, as recited in claim 5, wherein said light source comprises a light bulb and a pivot connector which is extended from said light bulb and is movably mounted at one of said columns in such a manner that when said pivot connector is adjustably slid along said respective column, said light bulb is selectively adjusted its vertical orientation between said top and bottom frame and is pivotally adjusted its light projecting angle.

8. The lightwall instrument, as recited in claim 1, further comprising a shading arrangement supported at said back face of said supporting frame, wherein said shading arrangement is made of nontransparent and nonreflecting material for preventing said light leaking from said back face of said supporting frame.

9. The lightwall instrument, as recited in claim 3, further comprising a shading arrangement supported at said back face of said supporting frame, wherein said shading arrangement is made of nontransparent and nonreflecting material for preventing said light leaking from said back face of said supporting frame.

10. The lightwall instrument, as recited in claim 7, further comprising a shading arrangement supported at said back face of said supporting frame, wherein said shading arrangement is made of nontransparent and nonreflecting material for preventing said light leaking from said back face of said supporting frame.

11. The lightwall instrument, as recited in claim 8, wherein said shading arrangement comprises two shading walls supported at said supporting frame, wherein each of said shading walls comprises a side panel and a back panel pivotally connected edge-to-edge, wherein said side panels of said shading walls are adapted to pivotally fold to cover at said side faces of said supporting frame while said back panels are adapted to pivotally fold to cover at said back face of said supporting frame, such that said side panels and said back panels are selectively adjusted their blocking angles to control the amount of light to reach said diffuser wall.

12. The lightwall instrument, as recited in claim 9, wherein said shading arrangement comprises two shading walls supported at said supporting frame, wherein each of said shading walls comprises a side panel and a back panel pivotally connected edge-to-edge, wherein said side panels of said shading walls are adapted to pivotally fold to cover at said side faces of said supporting frame while said back panels are adapted to pivotally fold to cover at said back face of said supporting frame, such that said side panels and said back panels are selectively adjusted their blocking angles to control the amount of light to reach said diffuser wall.

13. The lightwall instrument, as recited in claim 10, wherein said shading arrangement comprises two shading walls supported at said supporting frame, wherein each of said shading walls comprises a side panel and a back panel pivotally connected edge-to-edge, wherein said side panels of said shading walls are adapted to pivotally fold to cover at said side faces of said supporting frame while said back panels are adapted to pivotally fold to cover at said back face of said supporting frame, such that said side panels and said back panels are selectively adjusted their blocking angles to control the amount of light to reach said diffuser wall.

14. The lightwall instrument, as recited in claim 1, wherein the height of said diffuser wall is at least 2000 mm.

15. The lightwall instrument, as recited in claim 13, wherein the height of said diffuser wall is at least 2000 mm.

16. A method of creating a light effect of photograph and film by using a lightwall instrument, comprising the steps of:
(a) positioning a front face of a supporting frame towards a target object;
(b) supporting a light source at said supporting frame for generating light towards said front face of said supporting frame;
(c) selectively adjusting an orientation of a diffuser wall at said front face of said supporting frame to controllably project said light towards said diffuser wall, wherein said diffuser wall is adapted for softening said light being projected at said target object in condition that:
(i) only a middle diffusing wall unit is supported at said front face of said supporting frame while each of left and right diffusing wall units is pivotally stayed at a desired angle with respect to said middle diffusing wall unit;
(ii) pivotally folding one of said left and right diffusing wall units to overlap with said middle diffusing wall unit for enhancing light diffusion effect towards said target object; and
(iii) pivotally folding both said left and right diffusing wall units to overlap with said middle diffusing wall unit for further enhancing light diffusion effect towards said target object; and
(d) illuminating said target object by diffusing said light from said light source through said diffuser wall to create a planar light source towards said target object.

17. The method, as recited in claim 16, further comprising a step of (e) blocking undesired light from a back face of said supporting frame via a shading arrangement, wherein said shading arrangement is made of nontransparent and nonreflecting material for preventing said light leaking from said back face of said supporting frame.

18. The method, as recited in claim 17, wherein said shading arrangement comprises two shading walls supported at said supporting frame, wherein each of said shading walls comprises a side panel and a back panel pivotally connected edge-to-edge, wherein said side panels of said shading walls are adapted to pivotally fold to cover at side faces of said supporting frame while said back panels are adapted to pivotally fold to cover at said back face of said supporting frame, such that said side panels and said back panels are selectively adjusted their blocking angles to control the amount of light to reach said diffuser wall.

19. The method, as recited in claim 16 wherein the step (b), further comprises the steps of:
(b1) selectively adjusting the height of said light source within said supporting frame;
(b2) selectively adjusting the depth of said light source; and
(b3) selectively adjusting the direction of said light source.

20. The method, as recited in claim 18 wherein the step (b), further comprises the steps of:
(b1) selectively adjusting the height of said light source within said supporting frame;
(b2) selectively adjusting the depth of said light source; and
(b3) selectively adjusting the direction of said light source.
